(19) United States
(12) Patent Application Publication
(10) Pub. No.: US 2011/0216022 A1
(43) Pub. Date: Sep. 8, 2011

(54) DISPLAY INPUT APPARATUS AND DISPLAY INPUT METHOD

(75) Inventor: Tsutomu Kawamoto, Shizuoka (JP)

(73) Assignee: TOSHIBA TEC KABUSHIKI KAISHA, Tokyo (JP)

(21) Appl. No.: 13/037,560

(22) Filed: Mar. 1, 2011

(30) Foreign Application Priority Data
Mar. 2, 2010 (JP) 2010-45731

(51) Int. Cl. G06F 3/041

(52) U.S. Cl. 345/173

(57) ABSTRACT

According to one embodiment, a display input apparatus includes a recognition unit, a display unit, an input unit, a storage unit, and a control unit. The recognition unit recognizes identification information of an operator. The display unit displays an image. The input unit inputs operation information upon reception of a touch on a surface of the display unit. The storage unit stores therein a correction amount of the input unit or the display unit in association with the identification information of the operator. The control unit reads out from the storage unit the correction amount associated with identification information of the operator recognized by the recognition unit, and corrects at least one of the parameters of at least either the input unit or the display unit, based on the read-out correction amount.

### CROSS-REFERENCE TO RELATED APPLICATIONS

This application is based upon and claims the benefit of priority from Japanese Patent Application No. 2010-045731, filed on Mar. 2, 2010, the entire contents of which is incorporated herein by reference.

### FIELD

Embodiments described herein relate generally to a display input apparatus and a display input method in which a display process and an input process are performed based on correction amounts associated with identification information of an operator.

### BACKGROUND

Recently, as a display screen used in a touch POS (point of sales) terminal or the like, a touch panel type capable of not only displaying an image but also inputting operation information by directly touching the screen is widely used. However, in a display device with such a touch panel, an operator performs an operation by touching a small area on the touch panel with his/her finger, and therefore when a position of the line of sight of the operator changes, there may be some inconsistency between displayed coordinates and pressed coordinates on the display, which may affect an operation reading rate. Various techniques for solving this problem are known.

The related art provides a technique in which a camera is prepared to detect the height of an operator and pressed coordinates on a touch panel are corrected in accordance with the detected height, so that the mismatch caused by a difference in the angle of the line of sight due to the height is corrected to improve a reading rate of the touch panel.

However, in such configuration where a camera is used to detect the height of the operator, the use of the camera may cause a cost increase. Additionally, a position on the touch panel pressed by each operator is not only determined by the height, but also influenced by habits of each operator. Therefore, optimal correction is not necessarily ensured.

In light of the above issues in the related art, the present disclosure is directed to providing a display input apparatus and a display input method which can improve a reading rate without being influenced by individual differences among operators.

### BRIEF DESCRIPTION OF THE DRAWINGS

FIG. 1 is an external view showing an example of the external appearance of a display input apparatus according to an embodiment of the present disclosure.

FIG. 2 is a block diagram showing an example of an electrical configuration of the display input apparatus.

FIG. 3 is a side view showing a movable range of a display device of the display input apparatus.

FIG. 4 is a table showing exemplary correction amounts of a backlight brightness, a touch panel parallax correction value, and a sound volume of a speaker, in each angle of the display input apparatus.

FIG. 5 is a flowchart showing an example of a correction amount determination process of the display input apparatus.

FIG. 6 is a flowchart showing an example of the correction amount determination process of the display input apparatus.

FIG. 7 is a flowchart showing an example of a correction process of the display input apparatus.

### DETAILED DESCRIPTION

According to first embodiment, a display input apparatus includes a recognition unit, a display unit, an input unit, a storage unit, and a control unit. The recognition unit recognizes identification information of an operator. The display unit displays an image. The input unit inputs operation information upon reception of a touch on a surface of the display unit. The storage unit stores therein a correction amount of the input unit or the display unit in association with the identification information of the operator. The control unit reads out from the storage unit the correction amount associated with identification information of the operator recognized by the recognition unit, and corrects at least one of the parameters of at least either the input unit or the display unit, based on the read-out correction amount.

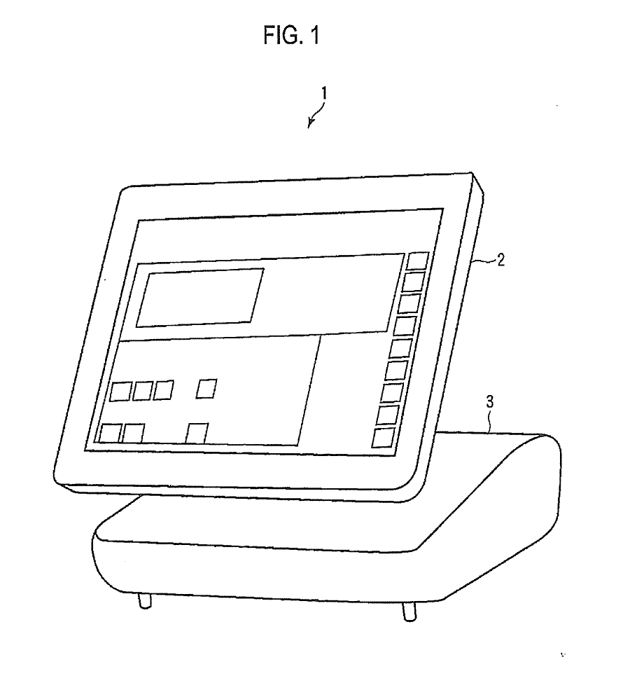

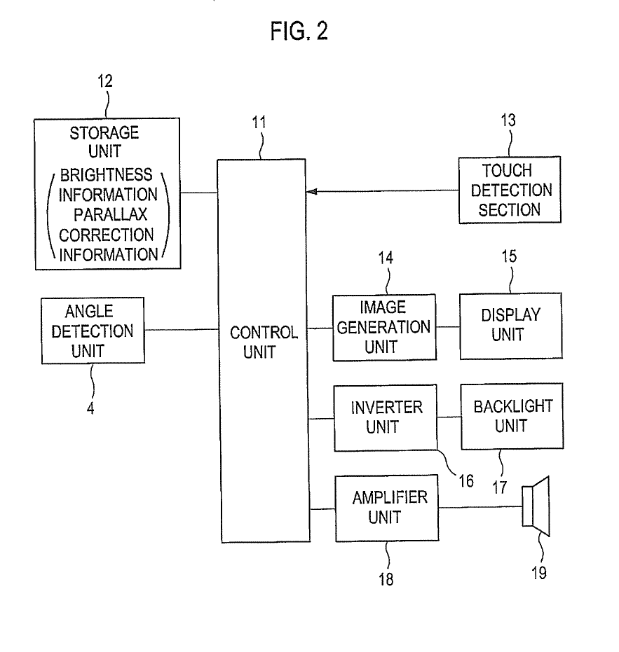

Embodiments will now be described in detail with reference to the drawings. According to an embodiment of the present disclosure, a display input apparatus 1 is used in a touch POS terminal or the like. The display input apparatus 1 includes a display device 2 having an image generation unit 14 mounted therein, and a main body device 3 which holds the display device 2 in such a manner that an inclination angle thereof is adjustable, as shown in FIG. 1. As shown in FIG. 2, the display input apparatus 1 also includes an angle detection unit 4, a control unit 11, a storage unit 12, a touch detection unit 13, an image generation unit 14, a display unit 15, a backlight unit 17, an inverter unit 16, an amplifier unit 18, and a speaker 19. The angle detection unit 4 detects the inclination angle of the display device 2. The control unit 11 controls an operation of the respective units. The storage unit 12 stores therein information of correction amounts of a backlight brightness of the display unit 15, a parallax correction value of the touch detection unit 13, and a sound volume value of the speaker 19. The touch detection unit 13 detects information of an operation performed by an operator through a touch panel. The image generation unit 14 generates information of an image to be displayed on the display unit 15. The display unit 15 displays the image generated by the image generation unit 14 on a liquid crystal screen or the like. The inverter unit 16 supplies a drive current to the backlight unit 17. The backlight unit 17 illuminates the liquid crystal screen of the display unit 15 from the back side thereof. The amplifier unit 18 amplifies an audio signal relating to the operation. The speaker 19 outputs the audio signal provided from the amplifier unit 18.

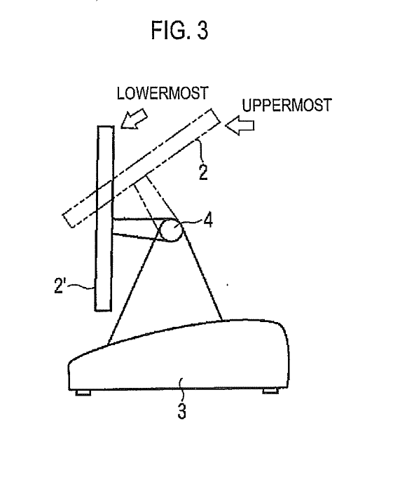

The display input apparatus 1 according to an embodiment of the present disclosure is included in a touch POS terminal or the like. As shown in FIG. 3, the display device 2 having the image generation unit 14 mounted therein may adjust its inclination angle with respect to the main body device 3. The angle detection unit 4 supplies the detection value of the angle to the control unit 11 as a detection signal.

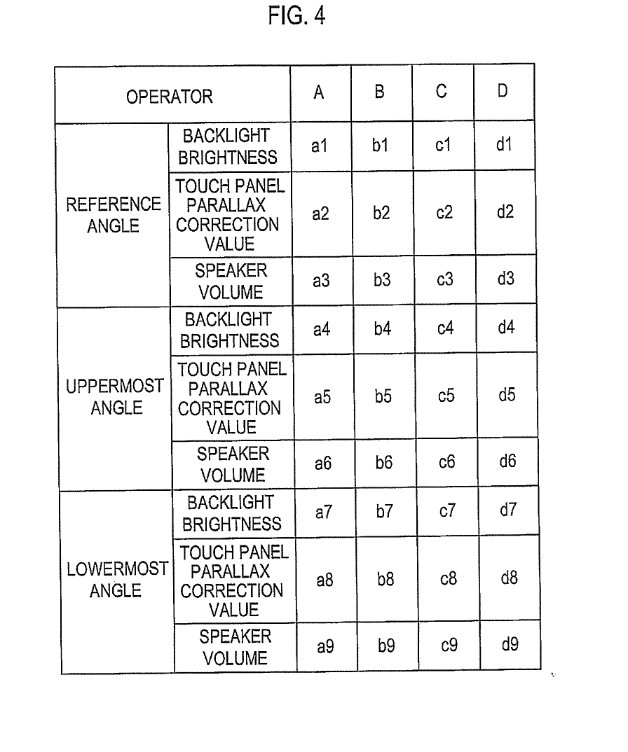

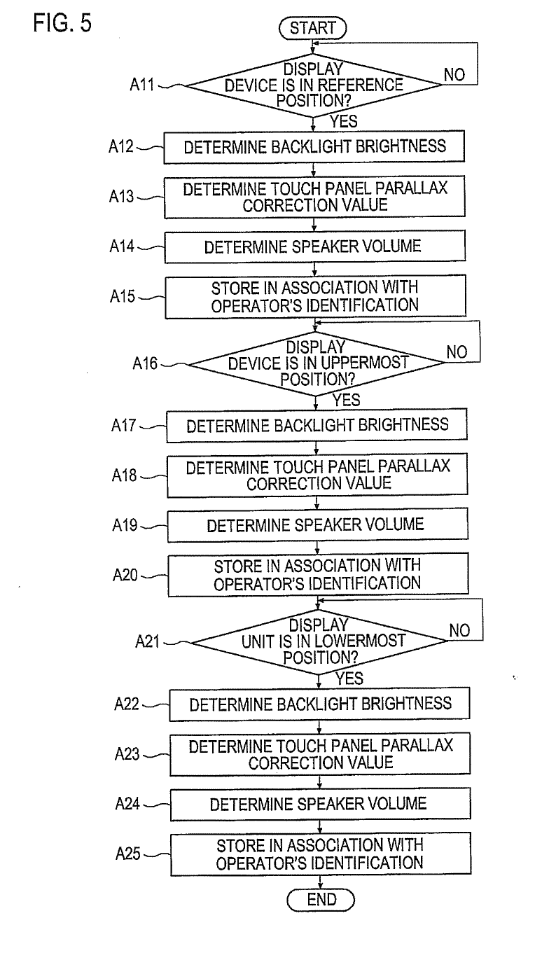

The display input apparatus 1 determines correction amounts and performs an adjustment process based on the determined correction amounts, as shown in the table including explanatory values in FIG. 4 and the flowcharts of FIGS. 5 to 7. After recognizing that a set mode is selected by the operator, the control unit 11 performs a correction amount determination process as follows. For example, the display unit 15 displays an indication for the operator to move the display device 2 to a reference position, and the operator moves the display device 2 to the reference position in accordance with this indication (Act A11). Then, when the operator operates an operation switch (not shown) or the like in order to obtain his/her favorite backlight brightness, the control unit 11 determines the backlight brightness (Act A12). Then, for example, in accordance with an indication displayed on the display unit 15, the operator touches sequentially indicated areas of the touch detection unit 13 on the display unit 15. In this manner, the control unit 11 calibrates the touch panel, and determines a difference between an actual display position and a position touched by the operator; as a parallax correction value (Act A13). Then, for example, in accordance with an indication displayed on the display unit 15, the operator operates a volume knob (not shown) or the like, so that the control unit 11 determines a sound volume which the operator considers to be optimal (Act A14). Upon completion of the above-described operations, the control unit 11 stores in the storage unit 12 the backlight brightness, the parallax correction value of the touch panel, and the sound volume of the speaker, as the correction amounts, together with the inclination angle of the display device and identification information of the operator (Act A15).

Then, if the control unit 11 detects that the operator has moved the display device 2 to an uppermost position as shown in FIG. 3 in accordance with an indication displayed on the display unit 15 for example (Act A16), the control unit 11 determines the backlight brightness upon the operator's operating the operation switch (not shown) or the like in order to obtain his/her favorite backlight brightness (Act A17). Then, for example, in accordance with an indication displayed on the display unit 15, the operator touches sequentially indicated areas of the touch detection unit 13 on the display unit 15. In this manner, the control unit 11 calibrates the touch panel, and determines a difference between an actual display position and a position touched by the operator, as a parallax correction value (Act A18). Then, for example, in accordance with an indication displayed on the display unit 15, the operator operates the volume knob (not shown) or the like, so that the control unit 11 determines a sound volume which the operator considers to be optimal (Act A19). Upon completion of the above-described operations, the control unit 11 stores in the storage unit 12 the backlight brightness, the parallax correction value of the touch panel, and the sound volume of the speaker, as the correction amounts, together with the inclination angle of the display device and identification information of the operator (Act A20).

Finally, if the control unit 11 detects that the operator has moved the display device 2 to a lowermost position as shown in FIG. 3 in accordance with an indication displayed on the display unit 15 (Act A21), the control unit 11 determines the backlight brightness upon the operator's operating the operation switch (not shown) or the like in order to obtain his/her favorite backlight brightness (Act A22). Then, in accordance with an indication displayed on the display unit 15, the operator touches sequentially indicated areas of the touch detection unit 13 on the display unit 15. In this manner, the control unit 11 calibrates the touch panel, and determines a difference between an actual display position and a position touched by the operator, as a parallax correction value (Act A23). Then, in accordance with an indication displayed on the display unit 15, the operator operates the volume knob (not shown) or the like, so that the control unit 11 determines a sound volume which the operator considers to be optimal (Act A24). Upon completion of the above-described operations, the control unit 11 stores in the storage unit 12 the backlight brightness, the parallax correction value of the touch panel, and the sound volume of the speaker, as the correction amounts, together with the inclination angle of the display device and identification information of the operator (Act A25). The correction of the sound volume of the speaker may be performed only once irrespective of the change of the inclination angle of the display device 2.

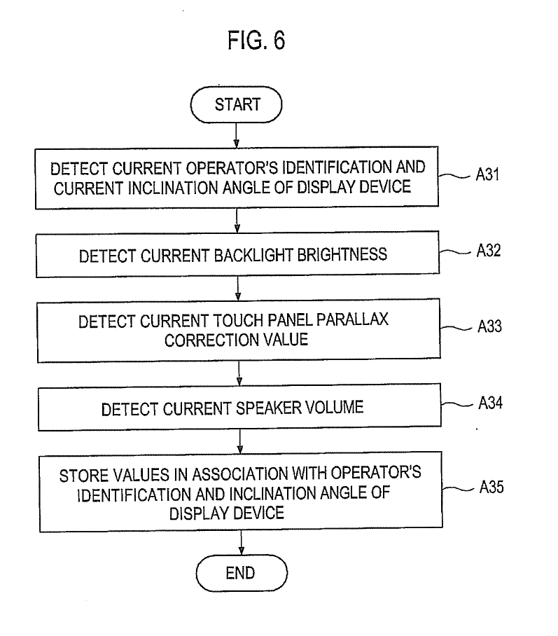

The respective correction amounts may not necessarily be determined in the above-described manner in which the operator performs the determination processes in the set mode in accordance with indications displayed on the operation screen. Alternatively, actual conditions in which an operator normally uses the display input apparatus 1 may be detected. In this case, the parameters in the detected conditions are determined to be optimal values for the operator. Thereafter, the control unit 11 automatically performs correction based on the optimal values. For example, as shown in the flowchart of FIG. 6, the control unit 11 detects identification information of a current operator and a current inclination angle of the display device 2 in a normal operation mode (Act A31). Then, the control unit 11 detects the backlight brightness currently used in the display device (Act A32). Then, the control unit 11 determines a difference between an actual display position and a position touched by the operator on the touch panel being currently used, as a parallax correction value (Act A33). In addition, the control unit 11 detects a sound volume set in the speaker 19 being currently used (Act A34). Then, the control unit 11 stores in the storage unit 12 the backlight brightness, the parallax correction value of the touch panel, and the sound volume of the speaker, as the correction amounts, together with the inclination angle of the display unit and identification information of the operator (Act A35).

In this manner, instead of storing correction amounts for each operator in the set mode, actual parameters are obtained and stored as optimal values while the operator normally uses the display input apparatus 1. Accordingly, appropriate correction amounts may be determined without laying an additional burden on the operator. In some embodiments, respective parameters may be adjusted by using both the correction amounts determined in the set mode as described above and the correction amounts determined in the normal use mode as described above.

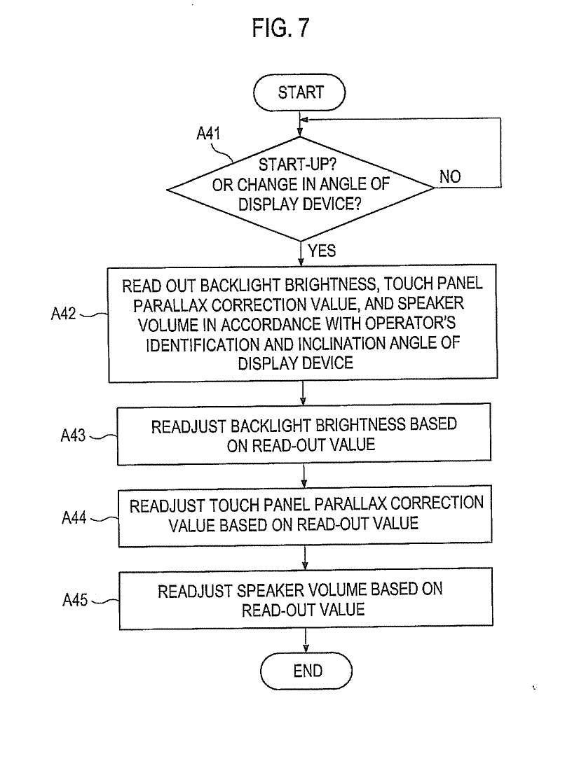

After, with reference to the flowchart of FIG. 7, a detailed description will be given of an adjustment process for adjusting the backlight brightness, the touch panel parallax correction value, the sound volume of the speaker, and the like, by using the correction amounts stored in association with the respective inclination angles of the display device 2 with respect to each operator as described above. To be specific, at a time of start-up of the display input apparatus 1 or upon a detection of a change in the inclination angle of the display device 2, the control unit 11 adjusts the backlight brightness, the touch panel parallax correction value, and the sound volume of the speaker (Act A41). The control unit 11 reads out from the storage unit 12 the correction amounts of, for example, the backlight brightness, the touch panel parallax correction value, and the sound volume of the speaker which are associated with the identification information of the current operator and the inclination angle of the display device 2 (Act A42).

The control unit 11 re-adjusts the brightness of the backlight unit 17 via the inverter unit 16 based on the read-out correction amount of the backlight brightness which is associated with the identification information of the operator and the inclination angle of the display device 2 (Act A43). Then, the control unit 11 re-adjusts coordinates detected by the touch detection unit 13 based on the read-out correction amount of the touch panel parallax correction value which is associated with the identification information of the operator and the inclination angle of the display device 2 (Act A44). Further, the control unit 11 re-adjusts the sound volume of the amplifier unit 18 based on the read-out correction amount of the sound volume of the speaker which is associated with the identification information of the operator and the inclination angle of the display device 2 (Act A45). As such, in the display input apparatus 1 such as a touch POS terminal, the backlight brightness, the touch panel parallax correction value, and the sound volume of the speaker 19 can be automatically adjusted to optimal values in association with the operator of the apparatus and the inclination angle of the display device 2. Therefore, a comfortable operating environment can be automatically realized for the operator despite individual differences. Additionally, when multiple operators use a single touch POS terminal, each operator may use the terminal with convenience and improved operability.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

In the above-described embodiments, the inclination angle of the display device 2 is used as a parameter in the process for determining respective correction amounts and in the process for adjusting the backlight brightness, the touch panel parallax correction value, and the sound volume of the speaker. However, it may not be necessary to use the parameter of the inclination angle of the display device 2 in the above processes. In some embodiments, the correction amounts of the backlight brightness, the touch panel parallax correction value, and the sound volume of the speaker are managed in association only with the identification information of the operator. In this case, each of the correction amounts is managed in association only with the identification information of the operator, irrespective of the inclination angle of the display device 2.

Although in the above-described embodiments, the correction amounts of the backlight brightness, the touch panel parallax correction value, and the sound volume of the speaker are determined and managed in the display input apparatus, the correction amounts may not be determined for all of the above three parameters. Any one of the correction amounts for these three parameters may be selectively determined and managed. A comfortable operating environment can be similarly provided to the operator even when a correction amount for any one of the above parameters can be managed in the display input apparatus 1.

All or some of the various embodiments described above can be implemented concurrently. The various embodiments described above allow those skilled in the art to realize the present disclosure. Furthermore, those skilled in the art may easily conceive various modified examples of these embodiments, and the present disclosure can be applied to various embodiments without inventive ability. Accordingly, the present disclosure extends over a broad range which does not contradict the disclosed principles and the novel features, and is not limited to the embodiments described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display input apparatus comprising:
a recognition unit configured to recognize identification information of an operator;
a display unit configured to display an image;
an input unit configured to input operation information through a touch on a surface of the display unit;
a storage unit configured to store therein a correction amount for the input unit or the display unit in association with the identification information of the operator; and
a control unit configured to read out from the storage unit the correction amount associated with identification information of the operator recognized by the recognition unit, and correct at least one parameter for either the input unit or the display unit, based on the correction amount read out from the storage unit.

2. The apparatus of claim 1, wherein the storage unit stores therein a correction amount of the input unit or the display unit in association with an inclination angle of a display device in which the display unit is mounted,
wherein the control unit reads out from the storage unit the correction amount associated with an inclination angle of the display device, and corrects at least one parameter for either an input process of the input unit or a display process of the display unit based on the read-out correction amount.

3. The apparatus of claim 1, wherein the correction amount of the input unit comprises a correction amount of a parallax of a touch panel.

4. The apparatus of claim 1, wherein the correction amount of the display unit comprises a correction amount of a brightness of a backlight of the display unit.

5. The apparatus of claim 1, wherein the correction amount comprises a correction amount of a sound volume of a speaker provided in the display input apparatus.

6. The apparatus of claim 1, wherein the storage unit stores therein the correction amount in a set mode of the display input apparatus.

7. The apparatus of claim 1, wherein the storage unit automatically stores therein the correction amount while the display input apparatus is used.

8. A display input method for use in a display input apparatus having a display unit with a touch panel, the method comprising:
recognizing identification information of an operator;
storing in a storage unit a correction amount for the touch panel and the display unit in association with the identification information of the operator;
when recognizing identification information of the operator, reading out from the storage unit the correction amount associated with the recognized identification information; and
correcting at least one parameter for either the touch panel or the display unit based on the correction amount read-out from the storage unit.

9. The method of claim 8, further comprising:
storing in the storage unit a correction amount of the touch panel or the display unit in association with an inclination angle of a display device in which the display unit is mounted;
reading out the correction amount associated with a current inclination angle of the display device from the storage unit; and
correcting at least one parameter for either the touch panel or the display unit based on the correction amount.

10. The method of claim 8, wherein the correction amount of the touch panel comprises a correction amount of a parallax of the touch panel.

11. The method of claim 8, wherein the correction amount of the display section comprises a correction amount of a brightness of a backlight of the display section.

12. The method of claim 8, wherein the correction amount comprises a correction amount of a sound volume of a speaker provided in the display input apparatus.

13. The method of claim 8, wherein the correction amount is stored in a set mode of the display input apparatus.

14. The method of claim 8, wherein the correction amount is automatically stored while the display input apparatus is used.

15. A display input apparatus comprising:
a display unit;
an input unit configured to input information through a touch on a surface of the display unit;
a recognition unit configured to recognize identification information of an operator; and
a control unit configured to adjust a least one parameter of either the input unit or display unit based on the identification information of the operator.

16. The apparatus of claim 15, wherein the parameter adjusted by the control unit is an inclination angle of the display unit.

17. The apparatus of claim 15, wherein the parameter adjusted by the control unit is a correction amount of parallax of the display unit.

18. The apparatus of claim 15, wherein the parameter adjusted by the control unit is a brightness of a backlight of the display unit

19. The apparatus of claim 15, wherein the parameter adjusted by the control unit is a sound volume of a speaker provided in the display input apparatus.

20. The apparatus of claim 15, wherein the control unit stores correction amounts for parameters that may be adjusted.
